(19) United States
(12) Patent Application Publication
(10) Pub. No.: US 2025/0369654 A1
(43) Pub. Date: Dec. 4, 2025

(54) HYDROFORMED CYLINDRICAL PILES

(71) Applicant: Nextracker LLC, Fremont, CA (US)

(72) Inventors: Bethany Ramadan, Fremont, CA (US); Abhimanyu Anil Sable, Hyderabad (IN); Ricardo Delgado-Nanez, San Jose, CA (US)

(21) Appl. No.: 19/227,594

(22) Filed: Jun. 4, 2025

Related U.S. Application Data
(60) Provisional application No. 63/655,784, filed on Jun. 4, 2024.

(51) Int. Cl. F24S 25/617; E02D 5/28; F24S 30/425; H02S 20/32

(52) U.S. Cl. CPC F24S 25/617; E02D 5/285; H02S 20/32; F24S 30/425

(57) ABSTRACT

A ground pile for a solar tracking system includes an elongate hollow tube extending longitudinally from a first end to a second end, one or more pair of support blades formed along the elongate hollow tube and extending away from a longitudinal axis of the elongate hollow tube. The one or more pair of support blades being formed by a hydroforming process.

### RELATED MATTER

This application claims the benefit of U.S. Provisional Patent Application No. 63/655,784, filed Jun. 4, 2024, the contents of which are incorporated herein by reference.

### TECHNICAL FIELD

This disclosure relates generally to solar power generation systems, and more particularly, to support structures for solar arrays within a solar tracking system.

### BACKGROUND

One of the most significant, costly, and time-consuming aspects relating to the manufacture and installation of solar trackers is the use of piers to support the solar modules. These piers, typically C-channels, W-beams, I-beams, or the like, are driven deep into the ground using costly heavy machinery such as pile driving equipment or by casting the piers in-situ using costly micro-pile equipment. As can be appreciated, each process not only requires costly equipment, but also requires a significant amount of time to complete, driving up the cost of installing solar tracking systems.

Additionally, solar tracker systems employ a significant amount of bearing housing assemblies, piers, damper assemblies, amongst others. As can be appreciated, the enormous number of these assemblies required to construct a solar tracking system requires a significant amount of material and takes a significant amount of time to install, further driving up the cost of installing solar tracking systems.

In view of these costly processes and designs, solar tracker piers and foundations that alleviate the need for costly and time-consuming processes involving heavy machinery and reduce the amount of material and labor required for installation are needed.

### SUMMARY

In general, the present disclosure relates to support structures for solar arrays within a solar tracking system. In a first example, a ground pile for a solar tracking system, may include an elongate hollow tube extending longitudinally from a first end to a second end, the elongate hollow tube having a longitudinal axis, and one or more pair of support blades formed along the elongate hollow tube, the one or more pair of support blades extending away from the longitudinal axis of the elongate hollow tube. The one or more pair of support blades may be formed by a hydroforming process.

Additionally or alternatively, the one or more pair of support blades may include a first spade blade formed on a first side of the elongate hollow tube and extending away from the longitudinal axis of the elongate hollow tube, and a second spade blade formed on a second side of the elongate hollow tube and extending away from the longitudinal axis of the elongate hollow tube at an angular position 180 degrees away from an angular position where the first spade blade extends away from the longitudinal axis of the elongate hollow tube.

Additionally or alternatively, a third spade blade may be formed on the first side of the elongate hollow tube, spaced apart along the longitudinal axis of the elongate hollow tube from the first spade blade, and extending away from the longitudinal axis of the elongate hollow tube, and a fourth spade blade formed on the second side of the elongate hollow tube, spaced apart along the longitudinal axis of the elongate hollow tube from the second spade blade, and extending away from the longitudinal axis of the elongate hollow tube at an angular position 180 degrees away from an angular position where the third spade blade extends away from the longitudinal axis of the elongate hollow tube.

Additionally or alternatively, a third spade blade and a fourth spade blade spaced apart from the first spade blade and the second spade blade along the longitudinal axis of the elongate hollow tube, wherein an angular position of the of the third spade blade and the fourth spade blade differ from an angular position of the first spade blade and the second spade blade.

Additionally or alternatively, the one or more pair of support blades includes a helical blade formed adjacent to the second end of the elongate hollow tube.

Additionally or alternatively, the one or more pair of support blades includes a first helical blade formed adjacent to the second end of the elongate hollow tube and a second helical blade formed adjacent to a central region of the elongate hollow tube, wherein the first helical blade and the second helical blade are spaced apart along the longitudinal axis of the elongate hollow tube from one another.

Additionally or alternatively, the one or more pair of support blades includes a first angled blade formed adjacent to the second end of the elongate hollow tube and extending away from the longitudinal axis of the elongate hollow tube, and a second angled blade formed adjacent to the second end of the elongate hollow tube and extending away from the longitudinal axis of the elongate hollow tube in a direction opposite the first angled blade.

Additionally or alternatively, the first angled blade extends from a first end to a second end and the first end extends away from the longitudinal axis of the elongate hollow tube at an angular position of between 25 and 45 degrees around the longitudinal axis of the elongate hollow tube from an angular position where the second end extends away from the longitudinal axis of the hollow tube, and the second angled blade extends from a first end to a second end and the first end extends away from the longitudinal axis of the elongate hollow tube at an angular position of between 25 and 45 degrees around the longitudinal axis of the elongate hollow tube from an angular position where the second end extends away from the longitudinal axis of the hollow tube.

Additionally or alternatively, the first angled blade and the second angled blade have a turbine blade design.

Additionally or alternatively, the one or more pair of support blades includes a first paddle blade formed adjacent to the second end of the elongate tube and extending away from the longitudinal axis of the elongate hollow tube, and a second paddle blade formed adjacent to the second end of the elongate hollow tube and extending away from the longitudinal axis of the elongate hollow tube at an angular position 180 degrees away from an angular position where the first paddle blade extends away from the longitudinal axis of the elongate hollow tube.

Additionally or alternatively, the one or more support blades each have a hollow cross-section.

Additionally or alternatively, the one or more pair of support blades includes a helical ridged section formed adjacent to the second end of the elongate hollow tube, the helical ridged section having a first outer diameter, a second outer diameter, and a third outer diameter, wherein the second outer diameter differs from the first outer diameter and the third outer diameter.

Additionally or alternatively, the one or more pair of support blades includes a vertical ridged section formed adjacent to the second end of the elongate hollow tube, the vertical ridged section extending longitudinally along the longitudinal axis of the elongate hollow tube and around a circumference of the elongate hollow tube.

In another example, a ground pile for a solar tracking system may include an elongate hollow tube extending longitudinally from a first end to a second end, the elongate hollow tube having a longitudinal axis, a first paddle blade formed adjacent to the second end of the elongate tube and extending away from the longitudinal axis of the elongate hollow tube, and a second paddle blade formed adjacent to the second end of the elongate hollow tube and extending away from the longitudinal axis of the elongate hollow tube at an angular position 180 degrees away from an angular position where the first paddle blade extends away from the longitudinal axis of the elongate hollow tube. The first paddle blade and the second paddle blade may be formed by a hydroforming process, and the first paddle blade and the second paddle blade may each have a hollow cross-section.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2A is a front side view of an example ground pile in accordance with the present disclosure;

FIG. 2B is a perspective view of the ground pile of FIG. 2A;

FIG. 3A is a front side view of an example ground pile in accordance with the present disclosure;

FIG. 3B is a perspective view of the ground pile of FIG. 3A;

FIG. 4A is a front side view of an example ground pile in accordance with the present disclosure;

FIG. 4B is a perspective view of the ground pile of FIG. 4A;

FIG. 5A is a front side view of an example ground pile in accordance with the present disclosure;

FIG. 5B is a perspective view of the ground pile of FIG. 5A;

FIG. 6A is a front side view of an example ground pile in accordance with the present disclosure;

FIG. 6B is a perspective view of the ground pile of FIG. 6A;

FIG. 7A is a front side view of an example ground pile in accordance with the present disclosure;

FIG. 7B is a perspective view of the ground pile of FIG. 7A;

FIG. 8A is a front side view of an example ground pile in accordance with the present disclosure;

FIG. 8B is a cross-sectional view of the ground pile of FIG. 8A, taken at line B-B;

FIG. 8C is a perspective view of the ground pile of FIG. 8A;

FIG. 9A is a front side view of an example ground pile in accordance with the present disclosure;

FIG. 9B is an enlarged view of a support blade of the ground pile as in FIG. 9A;

FIG. 10A is a front side view of an example ground pile in accordance with the present disclosure;

FIG. 10B is an enlarged view of a support blade of the ground pile as in FIG. 10A;

FIG. 11A is a front side view of an example ground pile in accordance with the present disclosure; and

FIG. 11B is an enlarged view of a support blade of the ground pile as in FIG. 11A.

### DETAILED DESCRIPTION

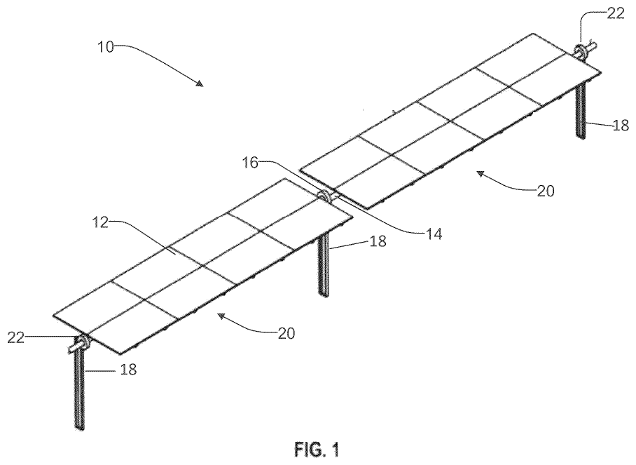

The present disclosure is directed to ground piles for a solar tracking system. FIG. 1 is an elevation view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Twisting of the torque tube 14 would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

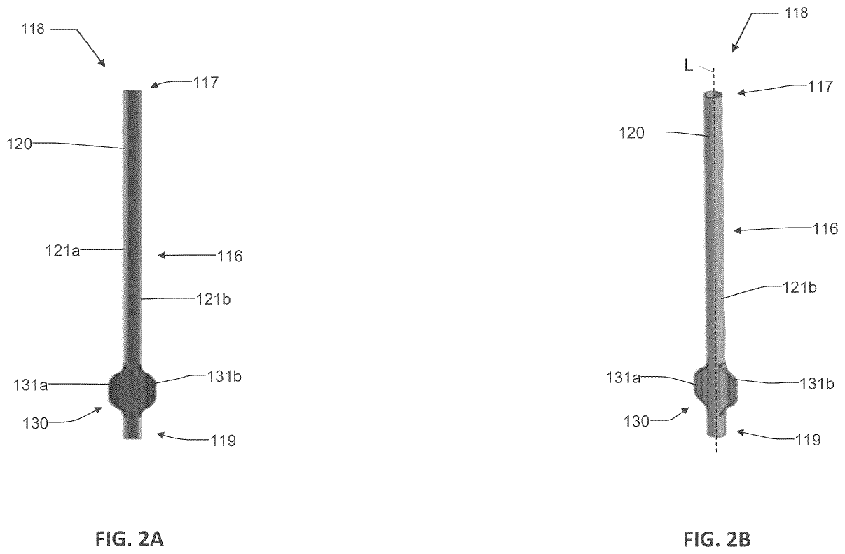

FIG. 2A is a front side view of an example ground pile 118 in accordance with the present disclosure, and FIG. 2B is a perspective view of the ground pile 118. The pile 118 may be an example of pile 18 as in FIG. 1. As shown in FIGS. 2A and 2B, the pile 118 may include an elongate hollow tube 120 extending longitudinally from a first end 117 to a second end 119 and having a longitudinal axis L. In some cases, the first end 117 of the hollow tube 120 may be open and the second end 119 of the hollow tube 120 may be open. In other cases, the first end 117 of the hollow tube 120 may be closed, and the second end 119 of the hollow tube may be closed. In some cases, one of the first end 117 or the second end 119 may be open and the other of the first end 117 or the second end 119 may be closed. In some cases, although not explicitly shown, a mount may be positioned proximate the first end 117, and the mount may include a series of one or more mounting holes that extend through the hollow tube 120.

As shown in FIGS. 2A and 2B, the pile 118 may include one or more pair of support blades 130 on the hollow tube 120. For example, the one or more pair of support blades 130 may include a first spade blade 131a formed on a first side 121a of the hollow tube 120, and a second spade blade 131b formed on a second side 121b of the hollow tube 120. The first spade blade 131a may extend away from the longitudinal axis L of the hollow tube 120 in a first direction, and the second spade blade 131b may extend away from the longitudinal axis L of the hollow tube 120 in a second direction opposite the first direction. The second spade blade 131b may extend away from the longitudinal axis L of the hollow tube 120 at an angular position 180 degrees around the longitudinal axis L from the angular position where the first spade blade 131a extends away from the longitudinal axis L of the hollow tube. The support blades 130 of the hollow tube 120 may be located along the longitudinal axis L of the hollow tube 120 closer to the second end 119. In some cases, the support blades 130 may be located adjacent or closer to the first portion 117, a central portion 116, or any other suitable portion along the longitudinal axis L of the hollow tube 120.

The pile 118 may be formed from aluminum, brass, carbon, stainless steel, copper, or other metal alloys. To the extent the pile 118 is formed via a hydroforming process, as described herein, the pile 118 may be formed of a material and a thickness appropriate for forming the particular components (e.g., support blades) described herein. For example, the first spade blade 131a and the second spade blade 131b may be formed by a hydroforming process of the hollow tube 120. In such cases, the hollow tube 120 may be fed into and held by the die. Pressurized fluid may then be applied to the inside of the hollow tube 120 to expand the hollow tube 120 to fill the die, thereby creating the one or more support blades 130, such as for example, the first spade blade 131a and the second spade blade 131b. Further, by using the hydroforming process, the one or more support blades 130 may include one or more types of blades. For example, as shown in FIGS. 2A and 2B, the one or more support blades 130 ay include the first spade blade 131a and the second spade blade 131b. Other types of blades, such as helical blades, angled blades, helical ridges, vertical ridges, and paddle blades will be discussed further herein. These are just examples. While it is shown in FIGS. 2A and 2B that there is one pair of support blades 130, it may be contemplated that there may be two pair, three pair, four pair, six pair, or any number of pairs of support blades as desired.

Forming the pile 118 along with the support blades 130 via the hydroforming process allows for the design to have multiple thickness in different areas as needed. Moreover, any desired holes (e.g., mounting holes) and/or slots needed within the pile 118 may be added directly during the hydroforming process rather than as a post-processing step. Further, formation of the hydroformed pile 118 via the hydroforming process, as discussed herein, may streamline the process of adding retention features (e.g., support blades 130) to the pile 118 during the manufacturing process. The pile 118 including the support blades 130 may be advantageous in diverse soil conditions (e.g., sandy soil, clay soil, silt soil, peat soil, loam soil, among others) by providing reliable support for solar trackers 10 in rural and/or urban environments.

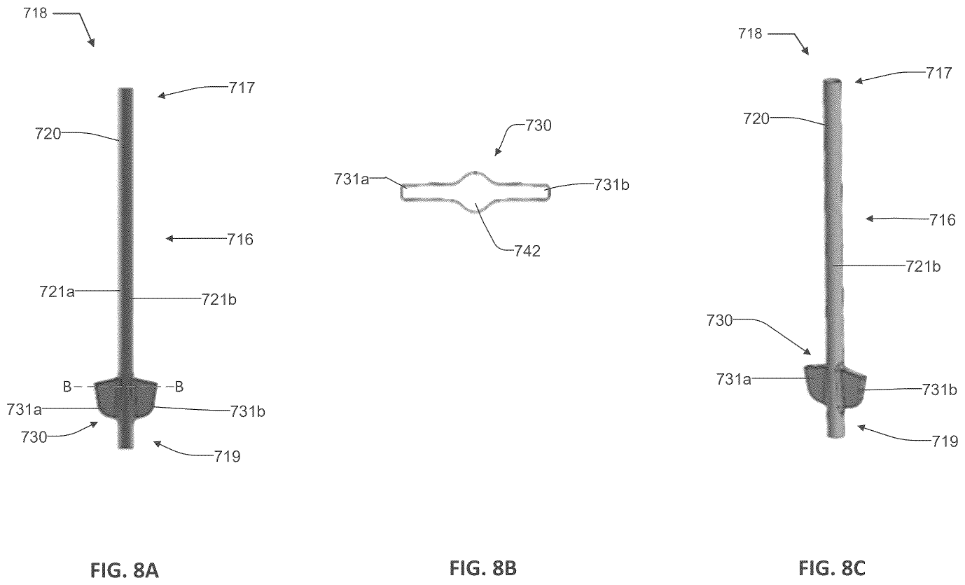

The hollow tube 120 may include a circular cross-section, and the first end 117 of the hollow tube 120 and the second end 119 of the hollow tube 120 include the same or a similar outer diameter, as shown in FIGS. 2A and 2B. Although this may not always be the case. In some cases, the first end 117 may have an outer diameter that is different than an outer diameter of the second end 119 (e.g., smaller than or larger than). In some cases, the hollow tube 120 may include a hexagonal cross-section, a square cross-section, a rectangular cross-section, a triangular cross-section, a W-cross-section, a polygonal cross-section, or the like. In some cases, a cross-section of the support blades 130 may be non-circular in shape as the support blades 130 extend in an outward direction from the longitudinal axis L of the hollow tube 120, as shown in further detail with respect to FIG. 8B. Although this may not always be the case. In some cases, the cross-section of the support blades 130 may include a circular cross-section. In other cases, the cross-section of the support blades 130 may include an oval cross-section, a polygonal cross-section, or any other suitable cross-section as desired.

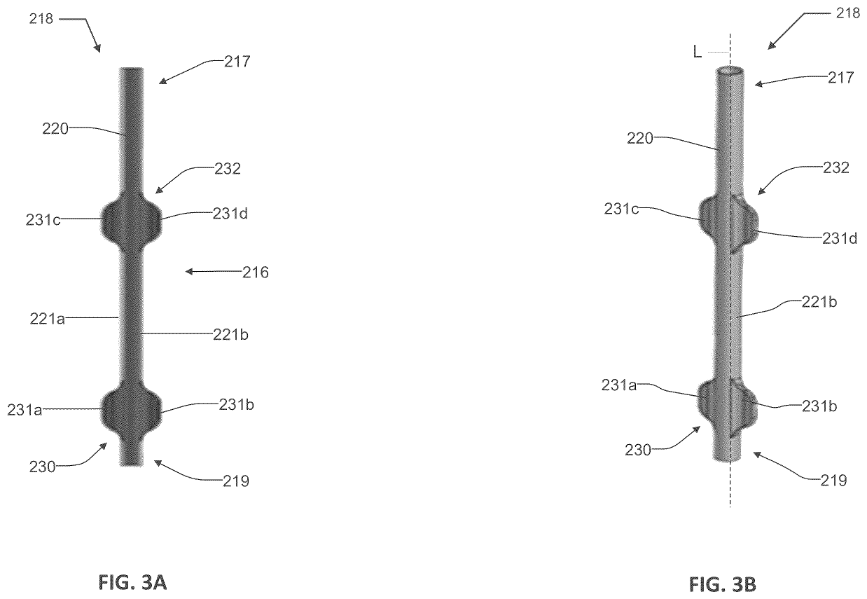

FIG. 3A is a front side view of an example ground pile 218 in accordance with the present disclosure, and FIG. 3B is a perspective view of the ground pile 218. The pile 218 is like the pile 118 shown in FIGS. 2A and 2B, except for the design of the support blades. As shown in FIGS. 3A and 3B, the hollow tube 220 may include a first pair of support blades 230 and a second pair of support blades 232. The first pair of support blades 230 may include a first spade blade 231a and a second spade blade 231b, and the second pair of support blades 232 may include a third spade blade 231c and a fourth spade blade 231d. As can be seen in FIGS. 3A and 3B, the second pair of support blades 232 may be spaced apart from the first pair of support blades 230 along the longitudinal axis L of the hollow tube 220. Adding the second pair of support blades 232 to the hollow tube 220 may provide additional lateral support along the longitudinal length of the pile 118, further reducing potential deflection of the pile 118 during excess loads due to wind, etc.

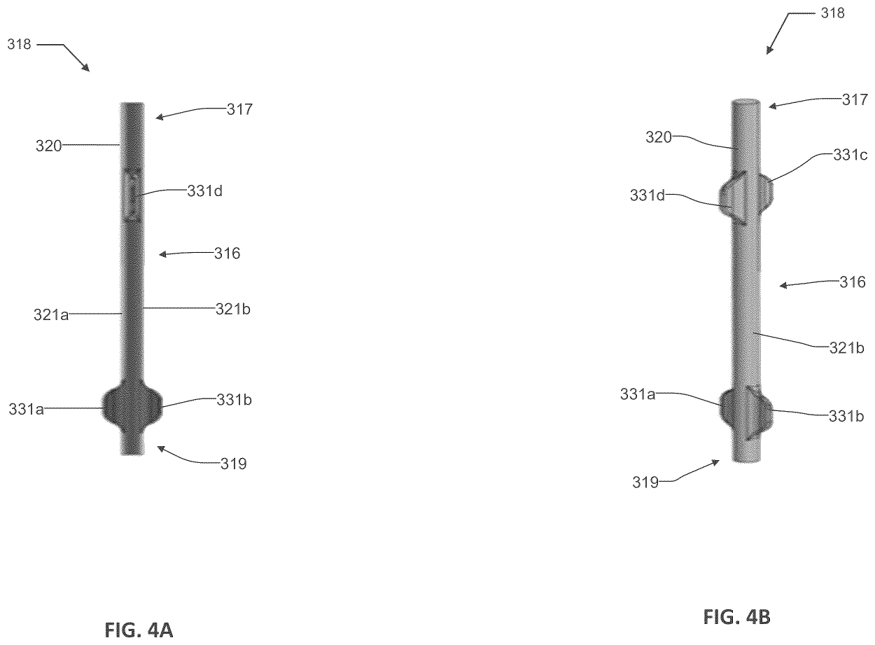

FIG. 4A is a front side view of an example ground pile 318 in accordance with the present disclosure, and FIG. 4B is a perspective view of the ground pile 318. The pile 318 is like the pile 118 shown in FIGS. 2A and 2B, except for the design of the support blades. As shown in FIGS. 4A and 4B, the hollow tube 320 may include a first pair of support blades 330 and a second pair of support blades 332. The first pair of support blades 330 may include a first spade blade 331a and a second spade blade 331b, and the second pair of support blades 332 may include a third spade blade 331c and a fourth spade blade 331d. As can be seen in FIGS. 4A and 4B, the second pair of support blades 332 may be spaced apart from the first pair of support blades 330 along the longitudinal axis L of the hollow tube 320.

The angular position of the second pair of support blades 332 around the longitudinal axis L of the hollow tube 320 may be at a different angular position of the first pair of support blades 330. As shown in FIGS. 4A and 4B, the angular position of the second pair of support blades 332 around the longitudinal axis L of the hollow tube 320 may differ from the angular position of the first pair of support blades 330 by 90 degrees. Such differing angular positions may provide the pile 318 with high lateral stability and resistance to dynamic loads.

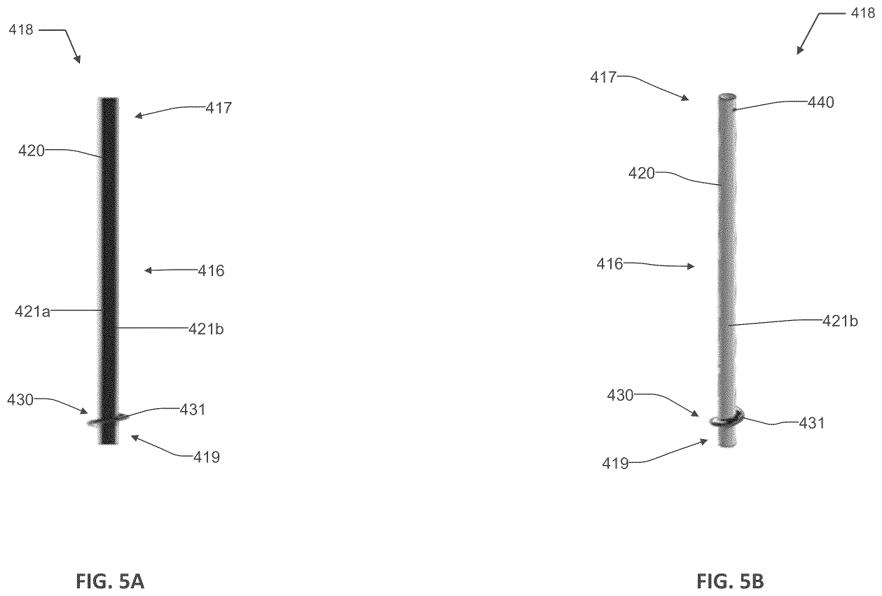

FIG. 5A is a front side view of an example ground pile 418 in accordance with the present disclosure, and FIG. 5B is a perspective view of the ground pile 418. The pile 418 is like the pile 118 shown in FIGS. 2A and 2B, except for the design of the support blades 430. As shown in FIGS. 5A and 5B, the design of the support blades 430 may include a helical support blade 431. The helical support blade 431 may be formed via the hydroforming process adjacent a second end 419 of the hollow tube 420. The helical support blade 431 may be configured to be screwed or threaded into the ground to anchor the solar tracker 10. The helical support blade 431 may extend a single or multiple revolutions around the longitudinal axis L. The helical support blade 431 may also extend complete or partial revolutions around the longitudinal axis L.

Further, in this embodiment, the hollow tube 420 may include a series of one or more mounting holes 440. While only one mounting hole 440 is visible in FIG. 5B, it may be contemplated that the pile 418 may include four mounting holes, six mounting holes, twelve mounting holes, twenty mounting holes, or any suitable number of mounting holes as desired. The mounting holes 440 may be used to attach solar tracking components such as for example, the bearings 22 and the drive mechanism 16, as shown in FIG. 1. In some cases, the mounting holes 440 may be configured to mount an adapter which may be used to drive the pile 418 into the ground.

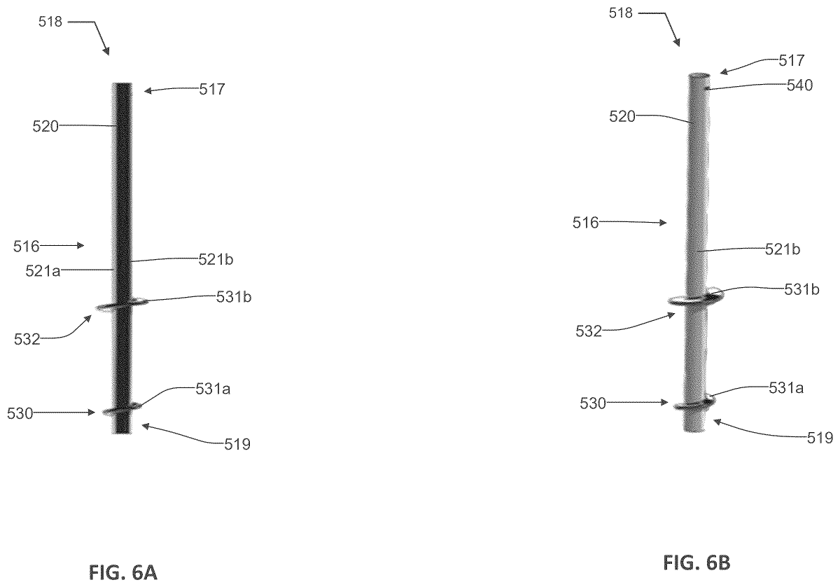

FIG. 6A is a front side view of an example ground pile 518 in accordance with the present disclosure, and FIG. 6B is a perspective view of the ground pile 518. The pile 518 is like the pile 118 shown in FIGS. 2A and 2B, except for the design of the support blades 530. As shown in FIGS. 6A and 6B, the design of the support blades 530 may include a first helical support blade 531 and a second helical support blade 532. The first helical support blade 531 and the second helical support blade 532 may be formed via the hydroforming process adjacent a second end 519 of the hollow tube 520 and a central region 516 of the hollow tube 520, respectively. The helical support blades 531, 532 may be configured to be screwed or threaded into the ground to anchor the solar tracker 10. The addition of the second hydroformed helical support blade 532 provides additional vertical load-bearing capacity.

Further, in this embodiment, the hollow tube 520 may include a series of one or more mounting holes 540. While only one mounting hole 540 is visible in FIG. 6B, it may be contemplated that the pile 518 may include four mounting holes, six mounting holes, twelve mounting holes, twenty mounting holes, or any suitable number of mounting holes as desired. The mounting holes 540 may be used to attach solar tracking components such as for example, the bearings 22 and the drive mechanism 16, as shown in FIG. 1. In some cases, the mounting holes 540 may be configured to mount an adapter which may be used to drive the pile 518 into the ground.

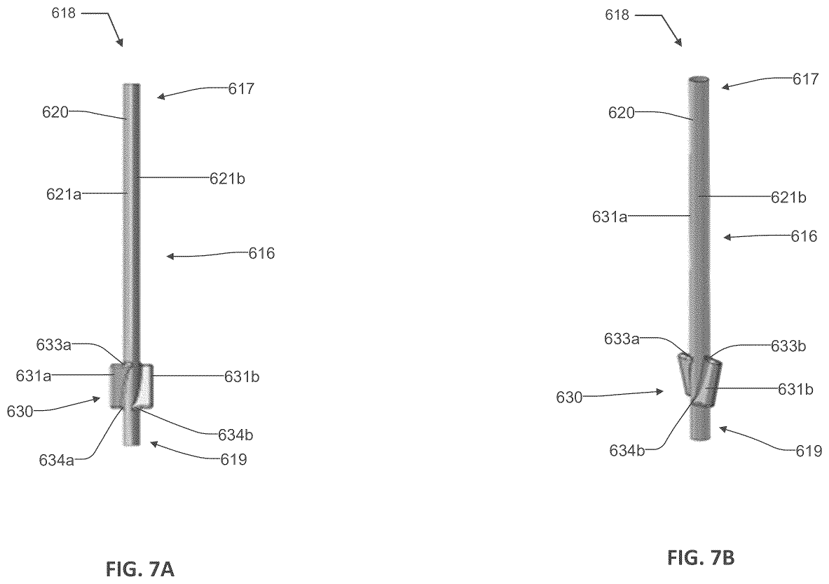

FIG. 7A is a front side view of an example ground pile 618 in accordance with the present disclosure, and FIG. 7B is a perspective view of the ground pile 618. The pile 618 is like the pile 118 shown in FIGS. 2A and 2B, except for the design of the support blades 630. As shown in FIGS. 7A and 7B, the design of the support blades 630 may include a first angled blade 631a and a second angled blade 631b, each having a turbine blade design. The first angled blade 631a may include a first end 633a formed on the hollow tube 620 and a second end 634a formed on the hollow tube 620. The first end 633a may extend away from the longitudinal axis L of the hollow tube 620 at an angular position of between 20 to 45 degrees around the longitudinal axis L from the angular position where the second end 634a extends away from the longitudinal axis L of the hollow tube 620. The first angled blade 631a may gradually transition in angular position as it extends from the first end 633a to the second end 634a.

The second angled blade 631b may include a first end 633b formed on the hollow tube 620 and a second end 634b formed on the hollow tube 620 such the second angled blade 631b. may be positioned at an angle of about 25° to about 45° in a direction opposite the first angled blade 631a. The support blades 630 may provide high lateral stability and resistance to dynamic loads and may be well-suited for solar tracker installations in regions prone to wind gusts and seismic activity. The first end 633b may extend away from the longitudinal axis L of the hollow tube 120 at an angular position of between 20 to 45 degrees around the longitudinal axis L from the angular position where the second end 634b extends away from the longitudinal axis L of the hollow tube 620. The second angled blade 631b may gradually transition in angular position as it extends from the first end 633b to the second end 633b. As the angular position changes along the longitudinal axis L, the angular position of the second angled blade 631b at any location along the longitudinal axis L may be remain offset by 180 degrees from the angular position of the first angled blade 631a at the same location along the longitudinal axis. Such angular positioning creates the turbine blade design in FIGS. 7A and 7B.

FIG. 8A is a front side view of an example ground pile 718 in accordance with the present disclosure, FIG. 8B is a cross-sectional view of support blades 730, taken at line B-B of FIG. 8A, and FIG. 8C is a perspective view of the ground pile 718. The pile 718 is like the pile 118 shown in FIGS. 2A and 2B, except for the design of the support blades 730. As shown in FIGS. 8A to 8C, the design of the support blades 730 may include a first paddle blade 731a and a second paddle blade 731b. Further, as shown in FIG. 8B, an internal surface 742 of the cross-section of the support blades 730 may be non-circular in shape as the support blades 730 extend in an outward direction from the longitudinal axis of the hollow tube 720. Although this may not always be the case. In some cases, the cross-section of the support blades 730 may include a circular cross-section. In other cases, the cross-section of the support blades 730 may include an oval cross-section, a polygonal cross-section, or any other suitable cross-section as desired.

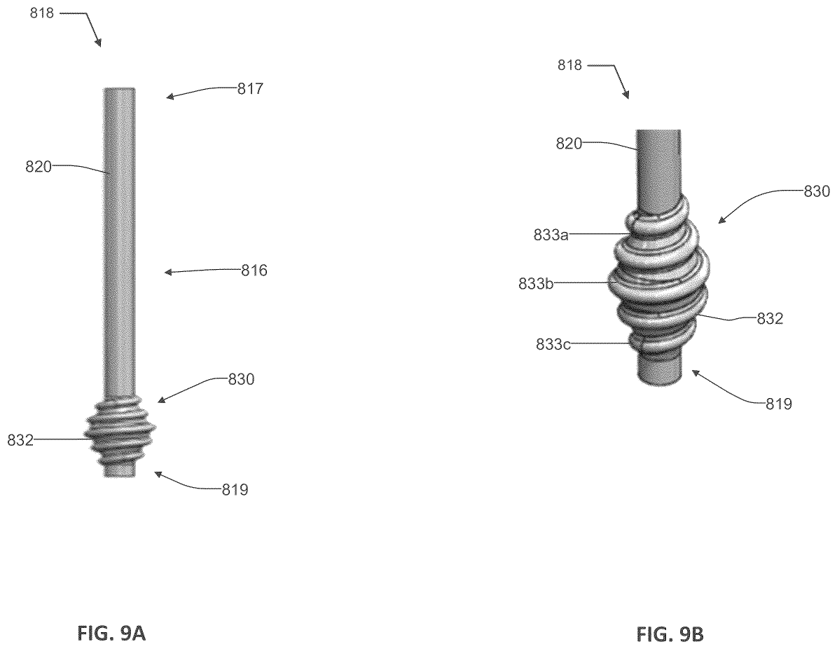

FIG. 9A is a front side view of an example ground pile 818 in accordance with the present disclosure, and FIG. 9B is an enlarged view of a support blade 830 of the ground pile 818. The pile 818 is like the pile 118 shown in FIGS. 2A and 2B, except for the design of the support blades 830. As shown in FIGS. 9A and 9B, the design of the support blade 830 may include a helical ridged section 832. The helical ridged section 832 may be formed via the hydroforming process adjacent a second end 819 of the hollow tube 820. The helical ridged section 832 (e.g., support blade 830) may be configured to be screwed or threaded into the ground to anchor the solar tracker 10 via rotational force. The helical ridged section 832 may extend a single or multiple revolutions around the longitudinal axis L. The helical ridged section 832 may also extend complete or partial revolutions around the longitudinal axis L.

The helical ridged section 832 may have a varying outer diameter around the longitudinal axis L of the hollow tube 820. For example, a first portion 833a of the helical ridged section 832 may include a first outer diameter, a central portion 833b may include a second outer diameter, and a second portion 833c may include a third outer diameter. As shown in FIG. 9B, the second outer diameter of the central portion 833b may be greater than the first and the third outer diameters. In some cases, the first outer diameter may be greater than the second and the third outer diameter. In some cases, the third outer diameter may be greater than the first and the second outer diameter. In other cases, the first, second, and third outer diameters may be equal.

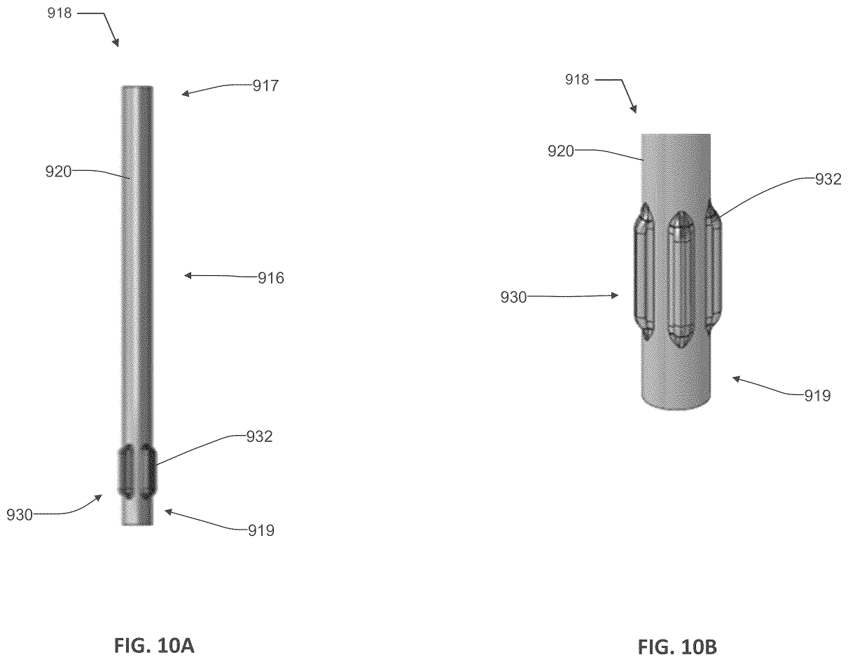

FIG. 10A is a front side view of an example ground pile 918 in accordance with the present disclosure, and FIG. 10B is an enlarged view of a support blade 930 of the ground pile 918. The pile 918 is like the pile 118 shown in FIGS. 2A and 2B, except for the design of the support blades 930. As shown in FIGS. 10A and 10B, the design of the support blades 930 may include a vertical ridged section 932 formed around the circumference of the hollow tube 920. The vertical ridged section 932 may be formed via the hydroforming process adjacent a second end 919 of the hollow tube 920. In some cases, the vertical ridged section 932 may be formed adjacent a central region 916 of the hollow tube 920.

The vertical ridged section 932 may extend longitudinally along the longitudinal axis L of the hollow tube 920. Having the vertical ridged section 932 extend longitudinally along the longitudinal axis L of the hollow tube 920 may allow the pile 918 to be easily installed using standard pile drivers and provides additional lateral support to the pile 918. The vertical ridged section 932 may each include a pyramidal shape, a rounded shape, a cuboidal shape, or any other shape as desired. In some cases, the vertical ridged section 932 may include two ridges, three ridges, five ridges, six ridges, ten ridges, or any other suitable number of ridges as desired.

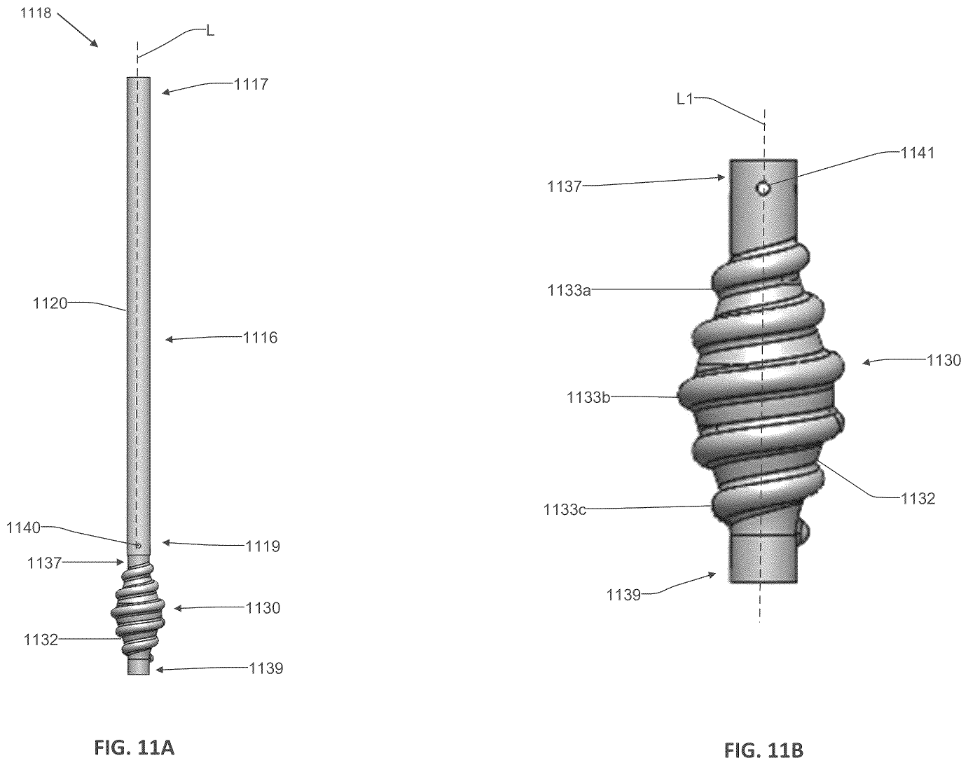

FIG. 11A is a front side view of an example ground pile 1118 in accordance with the present disclosure, and FIG. 11B is an enlarged view of a support blade 1130 of the ground pile 1118. The pile 1118 is like the pile 118 shown in FIGS. 2A and 2B, except for the design of the support blades 1130. In this embodiment, the hollow tube 1120 is formed via standard manufacturing processes while the support blade 1130 is formed via the hydroforming process described herein. Like pile 118, the pile 1118 may include an elongate hollow tube 1120 extending longitudinally from a first end 1117 to a second end 1119 and having a longitudinal axis L. In some cases, the first end 1117 of the hollow tube 1120 may be open and the second end 1119 of the hollow tube 1120 may be open.

The design of the support blade 1130 may include a helical ridged section 1132. The helical ridged section 1132 may be formed via the hydroforming process. The helical ridged section 1132 (e.g., support blade 1130) may be configured to be screwed or threaded into the ground to anchor the solar tracker 10 via rotational force. The helical ridged section 1132 may extend a single or multiple revolutions around a longitudinal axis L₁ of the support blade 1130. The helical ridged section 1132 may also extend complete or partial revolutions around the longitudinal axis L₁.

The helical ridged section 1132 may have a varying outer diameter around the longitudinal axis L₁ of the support blade 1130. For example, a first portion 1133a of the helical ridged section 1132 may include a first outer diameter, a central portion 1133b may include a second outer diameter, and a second portion 1133c may include a third outer diameter. As shown in FIG. 11B, the second outer diameter of the central portion 1133b may be greater than the first and the third outer diameters. In some cases, the first outer diameter may be greater than the second and the third outer diameter. In some cases, the third outer diameter may be greater than the first and the second outer diameter. In other cases, the first, second, and third outer diameters may be equal.

As shown in FIG. 11A, the second end 1119 of the hollow tube 1120 may include a first mounting hole 1140. While only one mounting hole is visible in FIG. 11A, it may be contemplated that the pile 1118 may include two mounting holes, four mounting holes, six mounting holes, twelve mounting holes, twenty mounting holes, or any suitable number of mounting holes as desired. The first mounting hole 1140 may be configured to couple the hollow tube 1120 to the support blade 1130. For example, in some cases, the second end 1119 of the hollow tube 1120 may be positioned over a first end 1137 of the support blade 1130. The first mounting hole 1140 may align with a second mounting hole 1141 positioned adjacent the first end 1137 of the support blade 1130, and a connection element, such as a blind rivet or a bolt (or any other suitable connection element), may be inserted through the first mounting hole 1140 and the second mounting hole 1141, thereby coupling the hollow tube 1120 to the support blade 1130. In some cases, the support blade 1130 may be coupled to the hollow tube 1120 via an alternative method such as, for example, resistance welding, or any other suitable type of connection method.

While it is shown in FIGS. 11A and 11B that the support blade 1130 includes the helical ridged section 1132, it will be appreciated that the support blade 1130 may include various hydroformed shapes and sizes, such as those described herein (e.g., spade blades, paddle blades, helical blades, etc.), without departing from the scope of the disclosure.

Various non-limiting exemplary embodiments have been described. It will be appreciated that suitable alternatives are possible without departing from the scope of the examples described herein.

1. A ground pile for a solar tracking system, comprising:
an elongate hollow tube extending longitudinally from a first end to a second end, the elongate hollow tube having a longitudinal axis;
one or more pair of support blades formed along the elongate hollow tube, the one or more pair of support blades extending away from the longitudinal axis of the elongate hollow tube;
wherein the one or more pair of support blades are formed by a hydroforming process.

2. The ground pile of claim 1, wherein the one or more pair of support blades includes a first spade blade formed on a first side of the elongate hollow tube and extending away from the longitudinal axis of the elongate hollow tube, and a second spade blade formed on a second side of the elongate hollow tube and extending away from the longitudinal axis of the elongate hollow tube at an angular position 180 degrees away from an angular position where the first spade blade extends away from the longitudinal axis of the elongate hollow tube.

3. The ground pile of claim 2, further comprising a third spade blade formed on the first side of the elongate hollow tube, spaced apart along the longitudinal axis of the elongate hollow tube from the first spade blade, and extending away from the longitudinal axis of the elongate hollow tube, and a fourth spade blade formed on the second side of the elongate hollow tube, spaced apart along the longitudinal axis of the elongate hollow tube from the second spade blade, and extending away from the longitudinal axis of the elongate hollow tube at an angular position 180 degrees away from an angular position where the third spade blade extends away from the longitudinal axis of the elongate hollow tube.

4. The ground pile of claim 2, further comprising a third spade blade and a fourth spade blade spaced apart from the first spade blade and the second spade blade along the longitudinal axis of the elongate hollow tube, wherein an angular position of the of the third spade blade and the fourth spade blade differ from an angular position of the first spade blade and the second spade blade.

5. The ground pile of claim 1, wherein the one or more pair of support blades includes a helical blade formed adjacent to the second end of the elongate hollow tube.

6. The ground pile of claim 1, wherein the one or more pair of support blades includes a first helical blade formed adjacent to the second end of the elongate hollow tube and a second helical blade formed adjacent to a central region of the elongate hollow tube, wherein the first helical blade and the second helical blade are spaced apart along the longitudinal axis of the elongate hollow tube from one another.

7. The ground pile of claim 1, wherein the one or more pair of support blades includes a first angled blade formed adjacent to the second end of the elongate hollow tube and extending away from the longitudinal axis of the elongate hollow tube, and a second angled blade formed adjacent to the second end of the elongate hollow tube and extending away from the longitudinal axis of the elongate hollow tube in a direction opposite the first angled blade.

8. The ground pile of claim 7, wherein the first angled blade extends from a first end to a second end and the first end extends away from the longitudinal axis of the elongate hollow tube at an angular position of between 25 and 45 degrees around the longitudinal axis of the elongate hollow tube from an angular position where the second end extends away from the longitudinal axis of the hollow tube, and the second angled blade extends from a first end to a second end and the first end extends away from the longitudinal axis of the elongate hollow tube at an angular position of between 25 and 45 degrees around the longitudinal axis of the elongate hollow tube from an angular position where the second end extends away from the longitudinal axis of the hollow tube.

9. The ground pile of claim 7, wherein the first angled blade and the second angled blade have a turbine blade design.

10. The ground pile of claim 1, wherein the one or more pair of support blades includes a first paddle blade formed adjacent to the second end of the elongate tube and extending away from the longitudinal axis of the elongate hollow tube, and a second paddle blade formed adjacent to the second end of the elongate hollow tube and extending away from the longitudinal axis of the elongate hollow tube at an angular position 180 degrees away from an angular position where the first paddle blade extends away from the longitudinal axis of the elongate hollow tube.

11. The ground pile of claim 1, wherein the one or more support blades each have a hollow cross-section.

12. The ground pile of claim 1, wherein the one or more pair of support blades includes a helical ridged section formed adjacent to the second end of the elongate hollow tube, the helical ridged section having a first outer diameter, a second outer diameter, and a third outer diameter, wherein the second outer diameter differs from the first outer diameter and the third outer diameter.

13. The ground pile of claim 1, wherein the one or more pair of support blades includes a vertical ridged section formed adjacent to the second end of the elongate hollow tube, the vertical ridged section extending longitudinally along the longitudinal axis of the elongate hollow tube and around a circumference of the elongate hollow tube.

14. A ground pile for a solar tracking system, comprising:
an elongate hollow tube extending longitudinally from a first end to a second end, the elongate hollow tube having a longitudinal axis;
a first paddle blade formed adjacent to the second end of the elongate tube and extending away from the longitudinal axis of the elongate hollow tube; and
a second paddle blade formed adjacent to the second end of the elongate hollow tube and extending away from the longitudinal axis of the elongate hollow tube at an angular position 180 degrees away from an angular position where the first paddle blade extends away from the longitudinal axis of the elongate hollow tube;
wherein the first paddle blade and the second paddle blade are formed by a hydroforming process; and
wherein the first paddle blade and the second paddle blade each have a hollow cross-section.

15. A ground pile for a solar tracking system, comprising:
an elongate hollow tube extending longitudinally from a first end to a second end, the elongate hollow tube having a longitudinal axis; and
a support blade extending from a first end to a second end, the first end of the support blade configured to be coupled to the second end of the elongate hollow tube;
wherein the support blade is formed by a hydroforming process.

16. The ground pile of claim 15, wherein the support blade includes a helical ridged section, the helical ridged section having a first outer diameter, a second outer diameter, and a third outer diameter, wherein the second outer diameter differs from the first outer diameter and the third outer diameter.

17. The ground pile of claim 15, wherein the second end of the elongate hollow tube includes a first mounting hole, and the first end of the support blade includes a second mounting hole, the first mounting hole configured to align with the second mounting hole to permit insertion of a connection element.

18. The ground pile of claim 15, wherein the support blade includes a first paddle blade extending away from a longitudinal axis of the support blade, and a second paddle blade extending away from the longitudinal axis of the support blade at an angular position 180 degrees away from an angular position where the first paddle blade extends away from the longitudinal axis of the support blade.
